(19) United States
(12) Patent Application Publication
(10) Pub. No.: US 2010/0274711 A1
(43) Pub. Date: Oct. 28, 2010

(54) Computer-based payment transaction system and repository

(76) Inventors: Stephen W. Purchase, Southhampton (GB); Robert Blower, Southhampton (GB); Ian Russell, Southhampton (GB); Mark Williamson, Southhampton (GB); John Pankhurst, North Sydney (AU); Tom Olsson, North Sydney (AU)

Correspondence Address: PARK, VAUGHAN & FLEMING LLP, 2820 FIFTH STREET, DAVIS, CA, 95618-7759, US

(21) Appl. No.: 11/664,827

(22) PCT Filed: Oct. 8, 2004
(86) PCT No.: PCT/GB2004/004286

§ 371 Date: Oct. 8, 2007

(51) Int. Cl. G06Q 40/00

(52) U.S. Cl. 705/39

(57) ABSTRACT

One embodiment of the invention relates, to a method of operating a payment transaction system maintained by a first party who receives an instruction for a first transaction. The instructed first transaction is directed from a second party to a third party, and includes a transaction date on which the payment transaction system is to give effect to the first transaction. The first party stores the transaction instruction into a database, and permits the third party to access those transaction instructions stored in the database that are directed to the third party. The first party then receives a request from the third party to bring forward at least in part the instructed first transaction. In response to the request, the first party re-directs the first transaction at least in part from the third party to the first party. In addition, the first party creates a new instruction for a second transaction in the system. The second transaction is directed from the first party to the third party and has a second transaction date which is prior to the first transaction date.

### FIELD OF THE INVENTION

The present invention relates to a computer-based payment transaction system, and more particularly to a system that includes a repository for storing a set of instructed transactions in conjunction with a transaction date. The repository may also be expanded to included ancillary data related to such transactions.

### BACKGROUND OF THE INVENTION

In conventional business activities, a company supplies a product, whether goods or services, to a customer, where the customer may be another company rather than an individual. The supplier then sends an invoice to the customer to obtain payment for the product. The delay between the provision of the product and the payment by the customer in respect of the invoice may cause financial problems for the supplier, if the supplier has to satisfy its own outgoings such as staff salaries or tax demands during this delay period. Although the supplier knows that it should receive funds as a result of the invoice in due course, those funds may not arrive quickly enough for the cashflow needs of the supplier.

One option is for a supplier to try to borrow money until the invoice is settled, but such borrowing can be expensive. In addition, the supplier may not always be able to obtain a loan, depending upon the financial situation of the supplier and the assets that it has to offer as security for any loan. As an alternative, the supplier may adopt a practice known as invoice discounting, in which the supplier uses the invoice itself as an asset (since the invoice represents an expectation of future payment). The invoice may therefore be used as collateral or security for provision of a loan, or may be traded to a third party. In the latter case, the third party becomes entitled to receive payment under the invoice when settled by the customer in lieu of providing immediate funds to the supplier. A related practice, used especially in the context of import/export trade, is known as forfaiting.

One drawback however with invoice discounting is that it is relatively expensive for the supplier. In addition, a supplier is normally only able to obtain advance funding in respect of part of the invoice value, for example, about 80 percent. These drawbacks reflect the risk that the third party incurs when taking on the invoice. For example, there is always a risk that the invoice has been issued in error (whether accidentally or fraudulently), and hence may be disputed by the customer in due course, in which case the amount payable under the invoice might be substantially reduced. Of course, the third party will generally have some recourse against the supplier in such circumstances, but this may be of little practical benefit if the supplier is already very short of finds.

Most businesses now rely upon computerised systems for the processing of invoices. For example, a supplier may transmit an invoice electronically to a customer, and the customer may then send instructions, also electronically, to its bank to transfer funds to the supplier's account in settlement of the invoice. The use of a computerised invoice system in conjunction with invoice discounting is described in “Where Cash and Trade Converge” by Craig Weeks and Alexandra Lara, in Trade and Forfaiting Review, May 2004, pages 24-25. However, existing computerised systems generally mirror conventional business practices, and do not consider the full opportunities offered by the increasing computerisation of financial systems. Such systems are also generally restricted to a one-to-one relationship between a bank and a customer of a bank, and do not offer full automation—i.e. there is normally still a paper-based component within the system.

### SUMMARY OF THE INVENTION

Accordingly, one embodiment of the invention provides a method of operating a payment transaction system by a first party. The method includes receiving an instruction for a first transaction, wherein the instructed first transaction is directed from a second party to a third party, and the transaction instruction includes a first transaction date on which the payment transaction system is to give effect to the first transaction. The method further includes storing the transaction instruction into a database, and permitting the third party to access transaction instructions stored in the database that are directed to the third party. The method further includes receiving a request from the third party to bring forward at least in part the instructed first transaction, and in response to the request, redirecting the first transaction at least in part from the third party to the first party, and creating a new instruction for a second transaction in the system. The second transaction is directed from the first party to the third party and has a second transaction date which is prior to the first transaction date.

In one particular implementation, the first party comprises a financial institution, such as a bank, the second party comprises a buyer, often a large corporate, and the third party comprises a supplier to the corporate. The payment transaction system therefore provides a mechanism for a supplier to exploit future dated payment instructions issued by the buyer to the bank in favour of the supplier by obtaining advance funds in relation to such instructions (generally in exchange for some service payment to the bank).

The supplier may obtain advance funds only in relation to a portion of the instructed payment, and such funds may be obtained immediately, or at a future date which is scheduled into the system. The bank may also offer other services in relation to future dated payment instructions, such as fixed currency conversions to remove currency risk for a supplier.

Another embodiment of the invention provides a method of operating a central repository for instructions for transactions. The method comprises receiving multiple transaction instructions from at least one originator, each transaction instruction specifying the originator and a target, and further specifying a date on which the transaction is to be initiated, wherein the multiple received transactions specify different targets. The received multiple transaction instructions are stored into a database, and a target is permitted to access from the database those transactions instructions out of the multiple received transaction instructions for which it is specified as a target. The method further includes initiating the multiple transaction instructions on the specified date for each transaction.

Again, the repository may be operated by a financial institution such as a bank, with a payment originator representing a buyer, and a payment target representing a supplier. Even if such a system does not support financing against payment instructions, it can still be very valuable for a supplier to have visibility of future dated payments in its favour, for example for cash flow management.

The invention also provides computer program product and system embodiments corresponding to the above methods. It will be appreciated that such computer program product and system embodiments may utilise and benefit from the same particular features as described above in relation to the method embodiment.

Note that the computer program product may be provided as a set of instructions recorded onto a physical medium, such as a CD, a DVD, and so on, or encoded into a transmission medium on a wireless or wired network such as the Internet. In either case, such instructions can then be loaded into a computer system for execution.

### BRIEF DESCRIPTION OF THE DRAWINGS

One or more embodiments of the invention will now be described in detail by way of example only with reference to the following drawings:

FIG. 1 is a high level overview of a payment transaction system in accordance with one embodiment of the invention;

FIG. 2 is a flowchart depicting certain operations of the payment transaction system of FIG. 1 for transmitting and receiving payment instructions in accordance with one embodiment of the invention;

FIG. 3 is a schematic diagram illustrating fields in a payment instruction in the payment transaction system of FIG. 1 in accordance with one embodiment of the invention;

FIG. 4 is a flowchart depicting certain operations of the payment transaction system of FIG. 1 for processing payment instructions in accordance with one embodiment of the invention;

FIG. 5 is a flowchart depicting certain operations of the payment transaction system of FIG. 1 for financing with payment instructions in accordance with one embodiment of the invention;

FIG. 6 is a schematic diagram illustrating the application architecture for the payment transaction system of FIG. 1 in accordance with one embodiment of the invention; and

FIG. 7 is a schematic diagram illustrating the physical architecture for the payment transaction system of FIG. 1 in accordance with one embodiment of the invention.

### DETAILED DESCRIPTION

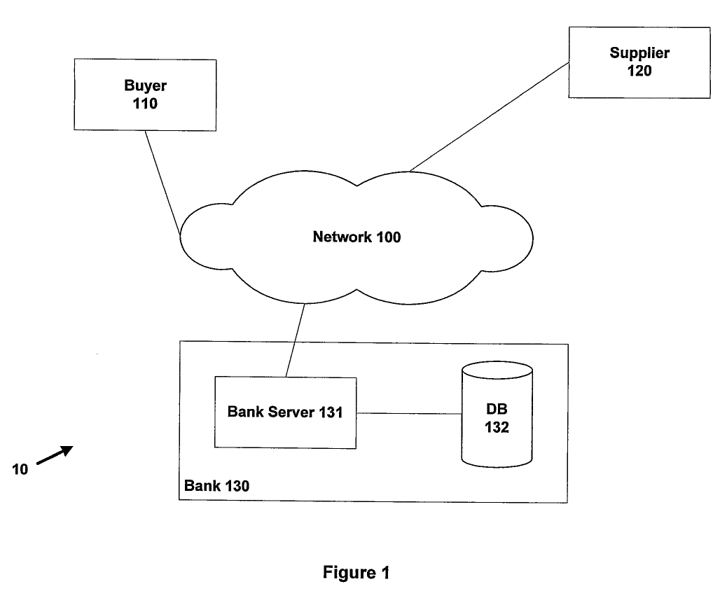

FIG. 1 illustrates a payment transaction system 10 in accordance with one embodiment of the invention. The three principal parties involved in system 10 are a buyer 110, a supplier 120, and a bank 130. In one particular implementation, the buyer 110 may be a large corporate organisation with a chain of regular suppliers, the supplier 120 may be any vendor having a regular supply relationship with the buyer, and the bank 130 is a provider of funds, usually with an existing banking relationship with buyer 110. (Note that the role of the bank 130 within the payment transaction system of FIG. 1 may be taken by any appropriate financial institution, such as a credit card company, a merchant bank, and so on).

The bank maintains a server system 131 which is linked to a database 132. It will be appreciated that server 131 and/or database 132 may each comprise multiple systems, depending upon overall processing requirements, availability (redundancy) considerations, and so on.

The bank 130, the buyer 110, and the supplier 120, are connected together by a network 100. In some implementations, there may be separate networks between the various parties, for example, there may be one network between buyer 110 and bank 130, and a separate network between supplier 120 and bank 130. The network(s) 100 provides for secure communications between the various parties. This can be achieved by the use of a secure communications protocol, such as https, over a public network, such as the Internet. Alternatively, the communications network itself may be secure or non-public, such as a corporate intranet or some form of dedicated extranet between the parties shown in FIG. 1. It will be appreciated that such a secure network may also run a secure communications protocol such as https.

Although FIG. 1 depicts only one buyer 110 and one supplier 120, it will be appreciated that system 10 may include many buyers and/or many suppliers dealing with a particular bank 130. Similarly, any given buyer 110 or supplier 120 may deal with multiple banks. In addition, while FIG. 1 shows bank 130 as responsible for running and managing bank server 131 and database 132, in another implementation, bank server 131 and database 132 may be maintained or hosted by a third party supplier. This third party supplier may also be responsible for providing the secure communications links between the various parties, i.e. for providing at least part of network 100. One possibility is that the bank server 131 and database 132 are maintained by a telco, since such an organisation generally has experience both with large computing systems and also secure communications.

In one particular embodiment, the payment transaction system 10 is built around a community of interest network (COIN), which may include various parties having shared interests or activities. For example, a large buyer with many suppliers might prefer or require that its suppliers subscribe to a particular payment transaction system 10. This helps to ensure uniformity of practice for the buyer. Likewise a bank may also put together a community of interest from amongst its clients for payment transaction system 10. Another possibility is that the buyer(s) 110 and supplier(s) 120 have a closely aligned business interest, such as through being prime contractor and subcontractors on a large project, and accordingly payment transaction system can then help to support financial activity within the project.

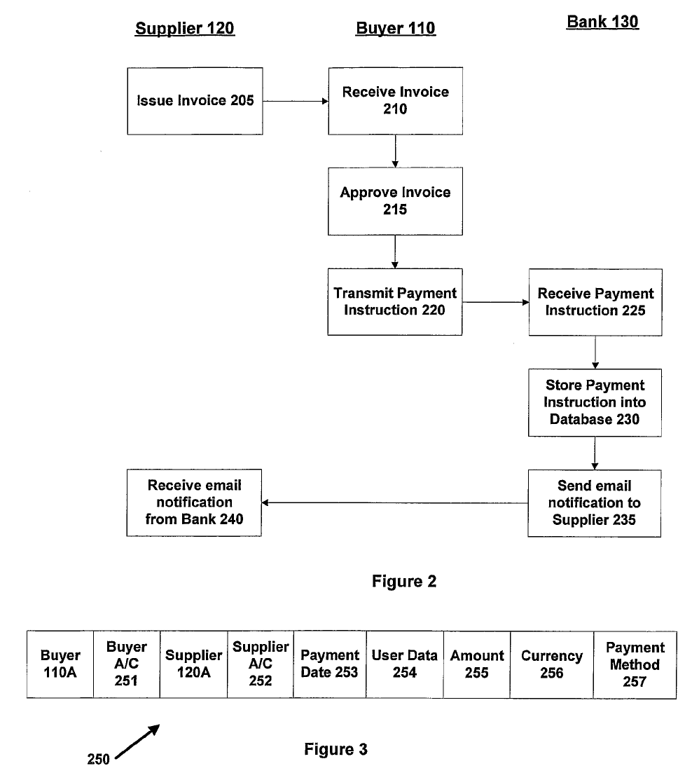

FIG. 2 is a schematic diagram showing operations for making a payment using the automated payment transaction system of FIG. 1 in accordance with one embodiment of the invention. It is assumed first of all that supplier 120 issues an invoice to buyer 110, normally in respect of goods or services that the supplier has provided to the buyer (operation 205). The invoice may be transmitted by supplier 120 to buyer 110 over network 100 or via any other appropriate mechanism (whether electronically, by paper copy, etc.).

Buyer 110 duly receives the invoice (operation 210), and then goes through its internal control procedures to determine whether or not to pay the invoice, for example confirming that the invoice matches an existing purchase order, and that the products supplied were of an acceptable standard. For most large buyers, the internal management and approval of invoices is performed within the context of an enterprise resource planning (ERP) system.

Assuming that everything is in order, buyer 120 approves the invoices (operation 215), and then transmits a payment instruction in respect of the invoice to bank 130 (operation 220). In general this payment instruction is sent electronically over network 100 from buyer 110 to bank 130. However, it may also be possible for buyer 110 to send the payment instruction in some other form (e.g. by hard copy letter), and for the details of the instruction to be then entered by a bank employee or other such person into the computer systems of bank 130. The payment instruction can be regarded as a future dated payment, and may be treated as irrevocable by the parties subscribing to the payment transaction system (barring special circumstances, such as fraud perhaps).

The payment instruction is received into the bank's server 131 (operation 225), and stored as a payment transaction within repository or database 132 (operation 230). In accordance with one particular implementation, the bank server 131 now transmits an electronic message or other appropriate form of communication to the supplier 120 (operation 235). When this electronic message is received by the supplier (operation 240), the supplier knows that the buyer 110 has approved the invoice, and that the buyer 110 has initiated processing for future payment of the invoice at some specified date, as described in more detail below. The payment instruction 250 in database 132 is available for inspection by supplier 120, thereby allowing supplier 120 to use the information provided in the instruction to reconcile the payment instruction against the previously issued invoice.

In existing electronic trading systems, payment instructions from the buyer 110 to the bank 130 have generally been private, in other words inaccessible to supplier 120. However, payment transaction system 10 stores such payment instructions on a central repository 132 which is accessible to supplier 120. More particularly, a supplier is able to review database 132 to see all payment instructions corresponding to future dated payments to that supplier. This is of considerable benefit to the supplier in planning its cash flow, since it knows in advance when funds are being received via the future dated payment instructions, and can therefore manage its liquidity accordingly.

In addition, as soon as the payment instruction becomes visible in database 132, the supplier 120 knows that the buyer 110 has approved the invoice, and also knows when remittance of the invoice will occur. Accordingly, there is no longer any need for supplier 120 to contact buyer 110 directly to inquire about the status of the invoice. Conversely, if a payment instruction corresponding to an invoice does not appear in the database 132 within the expected time, then this is an indication for the supplier that there may be a problem at the buyer's end in approving the invoice, and in this case it may be appropriate for the supplier to follow up with directly with the buyer. It will be appreciated that this is much more efficient than the conventional situation, where the buyer's processing of invoices is hidden from the supplier until actual payment is received by the supplier, which results in the supplier having to wait much longer to find out the payment date (or if there is any problem with the invoice).

FIG. 3 illustrates a payment instruction 250 in accordance with one embodiment of the invention, such as might be sent from the buyer 110 to the bank 130 at operation 220 in the flowchart of FIG. 2. Instruction 250 includes fields representing the buyer identity 110A and the supplier identity 120A, as well as corresponding account information (buyer 251, supplier 252). Accordingly, the bank knows that the payment instruction represents a transfer from the buyer's account 251 to the specified supplier's account 252. Note that as the payer, the buyer's account 251 will generally be maintained by bank 130, in order to allow proper authentication and validation of the payment instruction 250. On the other hand, as the payee, the supplier's account 252 may be at any bank (in many cases, a different bank from bank 130).

The date on which the payment is to be made from buyer 110 to supplier 120 is specified in payment instruction 250 as the transaction date 253. The payment instruction further specifies the amount to be paid 255 and the currency 256 in which the payment is to be made. The payment instruction therefore represents a future dated payment from the buyer to the supplier.

The payment instruction further includes details 257 concerning the particular mechanism by which the payment is to be implemented. For example, in the United Kingdom, the banking network supports the CHAPS system for same day payments, and the BACS systems for payments over three days; field 257 can therefore be used to specify in the UK whether the payment is to be made by CHAPS or by BACS.

Note that the payment transaction date 253 in instruction 250 represents the date at which the bank server 131 initiates the payment mechanism. The supplier will then receive the payment some time on or after this transaction date, depending upon the particular payment method selected for the instruction (e.g. same business day, next business day, etc). For example, if field 257 indicates that the payment is to be made by BACS, then the supplier will not receive its payment until three working days after the payment transaction date 253.

In addition, the payment instruction 250 includes user data 254. This can represent, for example, remittance advice that allows the supplier to reconcile the payment instruction against one or more invoices that have been issued to the buyer. Such an approach can be supported by incorporating the invoice number(s) (and perhaps invoice dates) that the payment corresponds to into user data 254. This allows the supplier 120 to perform a correlation between the payment instruction 250 and the invoice(s) originally issued by the supplier to the buyer (at operation 205 in FIG. 2).

It will be appreciated that the fields shown in FIG. 3 may be accompanied by many other fields depending on the particular circumstances, such as a purchase order number, an issue date representing when the payment instruction was issued, some form of error correcting code (ECC), and so on. If appropriate, this information could be incorporated into user data 254. Conversely, certain fields might be omitted from the record 250, depending upon the particular implementation. For example, the supplier and/or buyer identities 110A, 120A might be omitted if these are implicit or can be derived from the supplier account 252 and the buyer account 251 respectively. Alternatively, it might be possible to omit the buyer account 251 and/or the supplier account if the bank can uniquely identify either of these from the buyer identity 110A and/or the supplier identity 120A.

The particular format of payment instruction 250 may conform to one or more standards. For example, in one particular implementation, payment instruction 250 conforms to the relevant TWIST standard for payment instructions (see http://www.twiststandards.org/).

When the bank stores the future dated payment instruction 250 from the buyer at operation 230 (see FIG. 2) into database 132, the various fields shown in FIG. 3 can be stored as fields in the record for the payment instruction. Note that the system may add further fields to those received from the buyer, for example information concerning the date and time at which the payment instruction 250 was received into bank system 131.

Prior to saving the future dated payment instruction 250 into database 132, the bank server 131 may perform validation of the payment instruction (not shown in FIG. 2). For example, it may be confirmed that the buyer does have an account at the bank in question, that the transaction date for the instruction has not already passed, and that the amount in the instruction is below some predetermined credit limit for the buyer. If the instruction fails the validation, then the instruction is not saved into database 132, and appropriate exception handling can be performed.

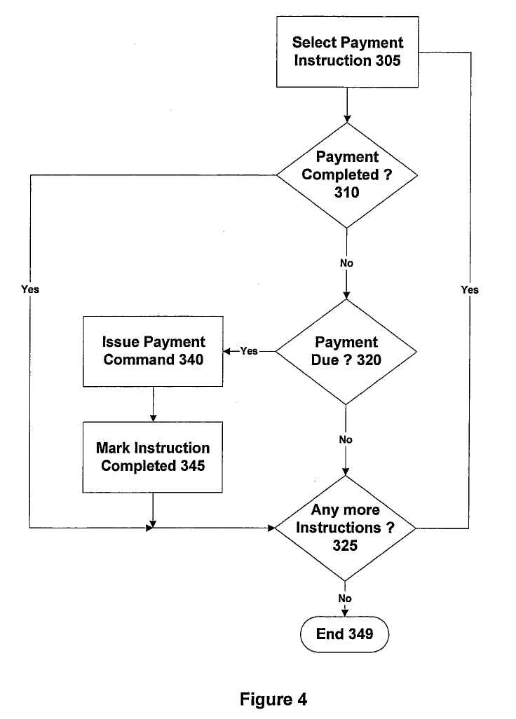

FIG. 4 is a simplified flowchart illustrating operations performed by bank server 131 in respect of future dated payment instructions 250 once they have been entered into database 132 (i.e. following operation 230 in FIG. 2) in accordance with one embodiment of the invention. The processing shown in FIG. 4 is iterative, in that a first instruction is selected from the database (operation 305), and various operations (as described below) are performed in respect of this instruction. Once processing of the selected operation has been completed, the system determines whether or not there are any more instructions to process (operation 325). If so, processing loops back to operation 305 to select the next payment instruction from database 132, thereby starting another iteration loop. When all the instructions have been processed, the outcome from the test at operation 325 is negative, and the method accordingly terminates at the end operation 349.

Within the processing loop, the system first checks to see if the payment for the selected instruction has already been completed (operation 310). If so, the system proceeds to consider the next instruction (operation 325). Alternatively, if the payment has not yet been completed, the system tests whether or not the payment corresponding to the payment instruction is now due (operation 320). This can be determined by comparing the payment date 253 in an instruction 250 (see FIG. 3) against the current date. If the payment is not yet due, the system again proceeds to consider the next instruction. However, if it is determined at operation 320 that the payment is now due, then the system issues a suitable payment command (operation 340). Such a command might comprise an instruction into the BACS or CHAPS system (depending upon the value of field 257 in FIG. 3) in order to give effect to the desired payment for instruction 250. It will be appreciated that systems for implementing the electronic transfer of funds, such as through BACS or CHAPS, are well-known to the person skilled in the art, and accordingly will not be described further herein.

Once the payment command has been issued, the system marks the corresponding payment instruction 250 as completed (operation 345), in order to ensure that the same payment is not made twice, and the system proceeds to determine again whether or not there are any more instructions to be processed (operation 325). Note that although the processing of FIG. 4 is depicted using an iterative model, it will be appreciated that in practice it is more likely for the system 131 to search database 132 for those outstanding records (i.e. payment instructions still to be completed) that are now due, rather than to process every instruction in turn.

Although there are existing implementations analogous to the processing of FIG. 4, such implementations have generally been in-house. For example, such processing might be used by an ERP system of buyer 110 to track outstanding invoices, and to determine when to make payments in respect of those invoices. However, in the processing of FIG. 4, the listing of payment instructions 250 is maintained in a central repository such as bank system 132 (rather than in-house). Consequently, the stored instructions are now visible to suitably authorised third parties, such as supplier 120.

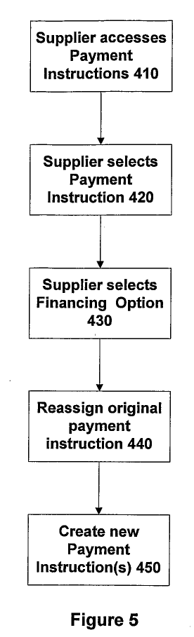

FIG. 5 represents a flowchart which presents a method illustrating how the pending payment instructions representing future dated payments from buyer 110 to supplier 120 in database 132 can be utilised for providing financing options to the supplier 120. The method commences when the supplier 120 accesses the payment instructions that are made out in its favour (operation 410), in other words those payment instructions where the supplier field 120A corresponds to the identity of the supplier accessing the bank system 131. Such access might be triggered by the supplier receiving an email notification of a new payment instruction in database 132 (corresponding to operation 240 in FIG. 2), and will generally be subject to various appropriate authorisation checks by the bank system 131.

The supplier now selects a future dated payment instruction that it would like to utilise for financing (operation 420). In some cases this may involve the supplier performing a review of all pending payment instructions in its favour in the database 132. Database 132 supports various reporting facilities for this purpose to allow a supplier to see the amount and payment dates of all relevant (authorised) future dated payment instructions in the database 132. Alternatively, the email notification of a new payment instruction in database 132, as sent at operation 235 in FIG. 2, may contain some form of hyperlink, and the supplier 120 is able to access the financing service directly in respect of this particular payment instruction by selecting the hyperlink from the email.

The bank system 131 now provides an offer to the supplier 120 to advance funds in respect of the selected invoice, and also provides information about any relevant fees or charges. In response to such an offer, the supplier enters details of the desired financing (operation 430). For example, the supplier may indicate at operation 430 whether it wants to obtain access now to all of the funds available in respect of the selected payment instruction, or just to a portion of those funds. The supplier may further indicate when it wants the funds to be available. The system may also require the supplier to formally acknowledge and accept the terms and conditions (including any charges) associated with the financing operation before the system can proceed further.

Once the supplier has specified details of the desired financing, the original payment instruction is assigned to the bank 130. One mechanism for achieving this would be to replace the supplier account details in field 252 with those of the bank itself. However, the transaction date of the payment instruction, corresponding to field 253 (see FIG. 3), is generally left unchanged (operation 440), so that the financing arrangement does not impact the buyer 110 (unless the buyer 110 and the bank 130 make some separate arrangement).

In addition, one or more new payment instructions may be created and stored into database 132 (operation 450). In particular, if the supplier is taking advantage of the whole amount of the available financing, then the system creates a single new payment instruction. The amount of this instruction (as per field 255, see FIG. 3) corresponds to the amount of the payment instruction selected by the supplier at operation 420. In some embodiments, the amount of the instruction payable to the supplier is reduced by the charges (if any) subtracted by the bank in connection with provision of the financing. Alternatively, the bank may also collect these charges via any other appropriate route (e.g. a monthly billing to the supplier).

Note that the transaction date of the new instruction is earlier than the date of the original payment instruction selected by the supplier 120 at operation 420. The bank therefore gives effect to the new payment instruction on this earlier transaction date, and subsequently gives effect to the original payment instruction, now assigned in favour of the bank 130, on the original transaction date, for example via the processing illustrated in FIG. 4. The consequence of the above processing is that the supplier obtains its funds (less any agreed fees) earlier than if the financing operation illustrated in FIG. 5 had not been performed.

On some occasions, the supplier may want to drawn down immediate funds in respect of a payment instruction, while on other occasions the supplier may want to schedule a future draw down of funds. In this latter situation, the supplier does not need the funds immediately, but still needs them at some future date prior to the original transaction date (for example to fund a salary run). The system therefore allows the supplier to specify the transaction date for the new instruction as appropriate. Note that the bank charges associated with the financing operation will generally vary with the transaction date of the new payment (the earlier the supplier draws down funds against a payment instruction, the higher the charges).

In some situations the supplier 120 may not want to access to the whole amount of the selected payment instruction, but rather may specify financing for only a portion of the original payment instruction (at operation 430). In this case at operation 450 the system creates two new payment instructions in the system (as well as again re-directing the original payment instruction 250 so that it is now made out in favour of bank 130 rather than supplier 120). Both of the new payment instructions are from the bank to the supplier, where the first corresponds to the portion of the original payment amount that is to be financed, and the second corresponds to the balance of the original payment amount (i.e. the portion that is not being financed). The transaction date for the first of the new instructions is brought forward compared to the transaction date of the original payment instruction (to provide early access to funds for the supplier), while the transaction date of the second instruction is the same as the transaction date of the original payment instruction.

The payment transaction system 10 allows the relevant parties, and especially supplier 120, to generate cash based on the payment instructions 250 in the supply chain for buyer 110. This cash is funded by the bank 130 acting as an intermediary. The supplier obtains early access to its receivables, less financing charges to the intermediary (which may then perhaps be shared with the buyer). The payment transaction system 10 may be implemented in the form of a managed hosted service operated by or on behalf of a bank.

It will be appreciated that while the flowchart of FIG. 5 has all payment instructions stored in database 132, in some implementations this database may only be used to hold future dated payment instructions from buyers to suppliers. If such a payment instruction is financed, then the bank may have separate systems to store instructions relating to payment from the bank to the supplier and/or to payment from the buyer to the bank.

The financing operations described above are highly flexible from a supplier perspective, and can be varied according to the particular amount and date required by the supplier. Note that multiple financing operations may be performed in respect of a single payment instruction. For example, the supplier may opt to draw down some funds from a payment instruction immediately, another portion of the funds a week later, and to leave the remainder of the funds with the original transaction date. The cost of the financing is readily visible to the supplier, since the system explicitly determines and indicates to the supplier the cost associated with the desired financing option prior to committal. In addition, the system also allows the supplier to select the payment mechanism used for the bank to provide the funds to the supplier, such as CHAPS or BACS. It will be appreciated that in general the bank will make a higher charge for a quicker payment mechanism, such as CHAPS, compared to a slower mechanism, such as BACS. (The charge for the payment mechanism is again readily visible to the supplier).

The payment transaction system 10 has important benefits for all participants, namely buyer 110, supplier 120, and bank 130. For supplier 120 the system enables visibility of future dated payments to assist in cash flow planning, as well as early access to funds based on these future dated payments. The cost of these funds, i.e. the amount subtracted as bank charges during the financing operation of FIG. 5, will generally be small compared to the cost of invoice discounting. This is because the financing is being performed with respect to a payment instruction rather than an invoice, and therefore this offers much greater certainty that the invoice will be settled (by issuing the payment instruction 250, the buyer 110 has in effect acknowledged and approved the invoice, thereby removing much of the risk encountered in invoice discounting).

The approach described herein is particular attractive for a supplier where buyer 120 is relatively large compared to supplier 110, since the bank is relying in effect on the credit-worthiness of the buyer rather than of the supplier. In other words, the payment transaction system 10 allows a supplier to obtain early payment from a bank, where the bank in turn expects future payment by the buyer. As a precaution however, the bank can set some form of credit limit for any given buyer 130, so that the total payment instructions in the system from the buyer to the bank cannot exceed some predetermined amount. If this limit is reached, the system may prevent suppliers from being able to draw down funds early against payment instructions from that buyer. This then ensures that the bank does not incur additional debt from the buyer (rather the debt remains from the buyer to the supplier). In practice, the system may alert the bank whenever this credit limit is approached—for example, whenever a fixed percentage (e.g. 80%) of the limit is reached—to give the bank the opportunity to make suitable financial arrangements with the buyer.

One attraction of the payment transaction system for buyer 110 is that now that its payment instructions are visible to supplier 120, so that the buyer no longer has to field enquiries from supplier 120 as to when a particular invoice is going to be settled (once the invoice has been approved and the payment instruction is visible to supplier 120 in database 132). In addition, buyer 110 may be able to extract some direct financial benefit from the payment transaction system. For example, buyer may obtain some agreed share of bank charges made by financing payment instructions (since it is the creditworthiness of the buyer and their participation in the scheme that underpins the bank's willingness to finance against a payment instruction). Another possibility is that the buyer may be able to leverage some benefit from the supplier, such as by setting a longer credit period for the settlement of invoices in its standard terms. Thus since the supplier is getting assistance with cash-flow because of its early exposure to the buyer's payment instructions, the buyer may impose a longer delay between approval of the invoice (and submission to database 132) and actual payment as specified by the transaction date within the payment instruction. In other words, the supplier will know about the payment earlier but may have to wait longer to actually receive the money in accordance with the revised standard terms (such delayed payment would clearly be in the financial interest of the buyer).

The payment transaction system 10 is also attractive to banks since it provides an additional avenue to raise money, as well as providing leverage to try to increase business with buyer 110 and supplier 120. The bank may further be able to expand its client base, for example if a particular large buyer requires all its suppliers to subscribe to the payment transaction system. In this case, the bank will have opportunities to sell services to suppliers that it would not otherwise have a business relationship with.

The payment transaction system 10 is also designed to avoid the risk of the bank becoming involved in any dispute between the buyer and the supplier. For example, a supplier may choose to dispute a payment instruction within the system, perhaps because the payment amount is for less than the value of the corresponding invoice. However, any such dispute is between the supplier and the buyer. In contrast, before a supplier can access financing in relation to a payment instruction, the system requires the supplier to accept the relevant payment. Hence the bank only becomes involved in financing payment instructions that have been explicitly accepted by the supplier, and hence should not be subject to dispute.

The bank may use payment transaction system 10 to offer services extending beyond the financing arrangements as described above. For example, based on the data available in the central repository of payment instructions, the bank may offer information services such as cash flow forecasts and balance predictions to the buyer(s) and/or supplier(s), as well as providing statistical details regarding average invoice settlement times, and so on.

The bank may also use the payment transaction system to offer services in relation to foreign currencies transactions. One such service is normalisation, whereby the bank converts payment instructions to a single common currency (using current exchange rates) in order to give a buyer or supplier a clearer picture of its cash flow position. Another possible use of payment transaction system 10 is to protect a buyer and/or supplier against currency fluctuations. For example, if the system contains a future payment instruction in US dollars made out to a UK supplier, the bank may offer the supplier to lock in a fixed exchange rate for this transaction. In this case, the original payment instruction in US dollars is assigned to the bank, and a new payment instruction from the bank to the supplier is created for the corresponding amount in UK sterling (less bank fees). Note that the payment date of this new transaction may be the same as the original payment instruction, but the supplier has now removed its currency risk.

Alternatively, the information on payment dates visible to supplier 120 from system 10 in itself allows the supplier to monitor and plan its exposure to currency fluctuations with more accuracy. This can then facilitate the supplier making separate arrangements for currency hedging (not necessarily with bank 130), and help the supplier to minimise the cost of such arrangements.

An analogous service to eliminate currency risk might also be offered to the buyer, for example where a UK buyer has to settle an invoice in US dollars. In this situation, the bank may take on responsibility for the payment instruction in dollars, and create a new payment instruction from the buyer to the bank in UK funds. Again the date of the new payment instruction may match the original payment instruction, with the amount corresponding to the original US dollar invoice plus bank charges.

In general terms therefore, the payment transaction system can be seen as a mechanism to support the visibility and trading of future dated payment instructions. A supplier can use the system to view and hence track payment instructions representing the future receipt of funds. This allows the supplier to predict its cash position in advance, and hence to make the best use of available finds. In addition, the bank can offer services to the buyers and/or suppliers to alter the timing, amount, and currency of these payment instructions for whatever reason (cash flow, tax planning, currency risk, etc) in return for a suitable payment to the bank.

In some implementations, the payment transaction system 10 may be enhanced to offer additional information to the supplier. For example, the buyer 110 may provide information about received (but unapproved) invoices into repository 132. This would give supplier 120 improved information about its likely future financial position, and also avoid the supplier contacting the buyer 110 in relation to those invoices for which payment instructions had not yet been generated. Other types of information that might be made accessible from buyer 110 via repository 132 to supplier 120 include purchase orders, goods received notes, credit notes, and so on. Such information can be obtained by payment transaction system 10 from the buyer ERP system (or other appropriate computer system), in the same way as payment instructions 250. Alternatively, such additional information might not be stored automatically within repository 132, but might only be obtained by payment transaction system 10 from buyer's computer systems in response to a specific supplier request. Note that such additional information will generally be provided in read only format to the supplier, for example to help determine likely future payments, and also as an aid to dispute resolution. Including more information within repository 132, and also providing better tools to analyse such information, will help to encourage supplier 120 to access payment transaction system 10 on a more regular basis. This is attractive to bank 130, since the more frequently the supplier accesses the payment transaction system 10, the greater the likelihood in general of them accepting some financing option from the system.

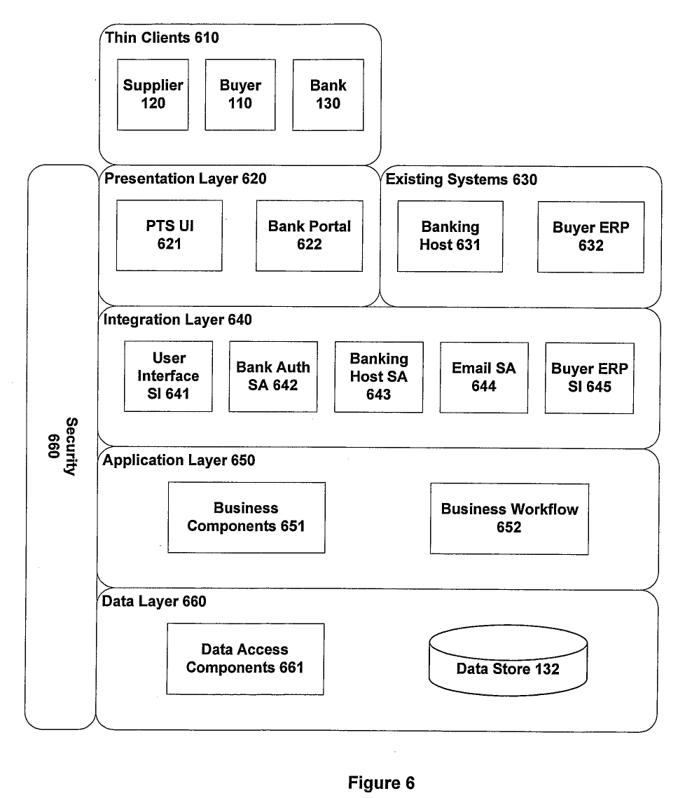

FIG. 6 illustrates the application architecture of payment transaction system 10 in accordance with one embodiment of the invention. The system 10 is based on a layered architecture, in which the business logic is contained in an application layer 650. The application layer is separate from a data layer 660 that holds the underlying data used for the application, and also from a presentation layer 620 that provides a client front end for the application. This layering approach (sometimes referred to as a three-tier model) ensures that the payment transaction system 10 is flexible in terms of the client front end and database system that is used with the application. The payment transaction system 10 further includes an integration layer 640 that allows the system to interact with existing systems 630, and also security services 660 that are provided to the various layers as appropriate. (It will be appreciated that existing systems 630 are not formally part of the payment transaction system 10, but rather ancillary to it).

The data layer 660 represents the lowest level of the architecture, and includes the database or data store 132, which is used to store information about the payment instructions 250 representing future dated payments, and also any financing operations that have been performed in respect of these payment instructions. The records in data store 132 can be accessed and manipulated by appropriate data access components 661, which are also located in data layer 660.

The application layer 650 sits above the data layer 660 and comprises business components 651 and business workflow 652. These components implement the general business logic to provide the processing shown in the flowcharts of FIGS. 4 and 5.

The integration layer 640 sits above the application layer 650, and includes various service interfaces (SIs) and service adapters (SAs) to allow the payment transaction system 10 to operate with existing systems 630. In particular, the integration layer 640 includes a service interface 645 for communication with a buyer ERP system 632. This provides a mechanism for the system 10 to receiving incoming payment instructions and any related information from the buyer 110 (corresponding to operation 225 in FIG. 2). The integration layer 640 further includes an email service adapter 644, such as for interacting with an email system (not shown in FIG. 6) to send an email notification to a supplier 120 whenever a new payment instruction in its favour is received into system 10 (corresponding to operation 235 in FIG. 2).

The integration layer further includes a service adapter 643 for communication with a banking host system 631. This service adapter can be used to transmit payment commands when they become due for BACS or CHAPS payments as appropriate (corresponding to operation 340 in FIG. 4).

The integration layer further includes a service adapter 642 for communication with a bank authentication system (not shown in FIG. 6). This authentication system can be used to monitor and restrict the operations of the various parties involved with payment transaction system 10. For example, staff at supplier 120 may generally be able to access database 132 to see payment instructions in favour of the supplier. However, only restricted staff at the supplier 120 may be authorised to initiate a financing operation (such as shown in the flowchart of FIG. 5) in respect of a payment instruction. The system supports such controls by providing multiple roles that are permitted to perform different operations, and each user is allocated to a particular role. The bank authentication system then ensures that a user is not able to perform an operation that is not permitted for the role to which that user has been allocated. The bank authentication system can also be used to check that the payments outstanding from a buyer to the bank do not exceed the credit limit of the buyer.

The integration layer further includes a system interface 641 for providing a user interface, which can be accessed via presentation layer 620. In one embodiment, two particular routes into payment transaction system 10 are supported. The first is via a dedicated user interface 621 for the payment transaction system, while the second is via a bank portal 622 (both part of presentation layer 620). The bank portal 622 represents a web-site or other facility whereby users can generally access a range of (on-line) services from the bank. The user interface provided via bank portal 622 may differ from the dedicated user interface 621 so as to conform with a standardised interface for all services available from bank portal 622, although in general the same level of functionality will be available. The presentation layer 620, whether the bank portal 622 or the dedicated user interface 621, can then be accessed by thin client 610 for the supplier, buyer, and also the bank. These thin clients 610 generally represent desktop workstations, such as a conventional personal computer, running a web browser, such as Internet Explorer.

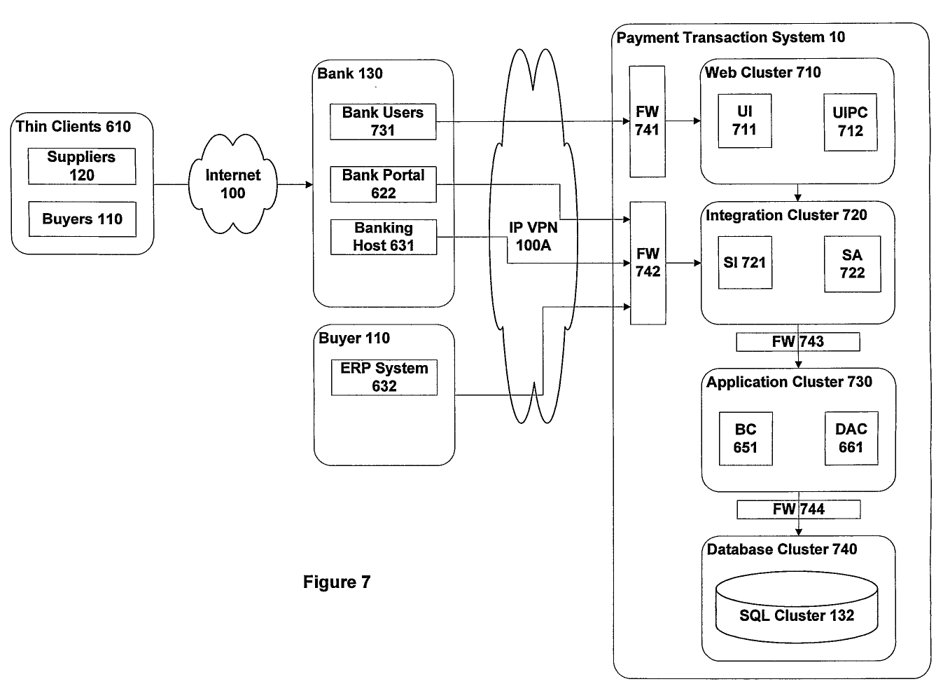

FIG. 7 illustrates the physical architecture of payment transaction system 10 in accordance with one embodiment of the invention. The thin clients 610 corresponding to the supplier and the buyer access the system via Internet 100, for example using a web-based interface via html and https.

Various bank systems access the payment transaction system 10 using an internal network, namely an IP virtual private network (VPN) 100A. Bank systems that access the payment transaction system 10 in this manner may include individual bank users 731, bank portal 622, and the banking host 631. Bank users 731 comprise client systems analogous to supplier 120 and buyer 110, and generally access the payment transaction system 10 through the same web interface using html and https. Banking portal 122 may access the payment transaction system 10 using the simple object access protocol (SOAP) on top of https, while a variety of mechanisms are supported for the banking host 631 to communicate with the payment transaction system 10, including SOAP, FTP, and SMTP, as well as some specialised API.

In addition, FIG. 7 depicts an ERP system 632 for buyer 110. This ERP system will generally have a separate interface into the payment transaction system (i.e. distinct from the other buyer client systems), which may be implemented across the VPN 100A. Again, a variety of mechanisms are supported for the buyer ERP system 632 to communicate with the payment transaction system 10, including SOAP, FTP, and SMTP, as well as some specialised API.

The physical architecture of the payment transaction system itself is layered, in broad correspondence with the layering of the application architecture. At the top of this layering is a web cluster 710, which provides a user interface 711 and user interface controls 712 for clients accessing the payment transaction system via web-based protocols such as html.

Beneath the web cluster 710 is the integration cluster 720, which includes the various service interfaces 721 and service adapters 722 described above with reference to the integration layer 640 of FIG. 6. Note that the bank portal 622, the banking host 631 and the ERP system 632 communicate directly with the integration cluster 720 (rather than going through web cluster 710). Underneath the integration cluster 720 is an application cluster 730, which includes business components 651 and data access components 661. Finally, at the bottom of the architecture is the database cluster 740, which in one embodiment is implemented by a structured query language (SQL) cluster 132 to provide a data store for payment instructions.

The payment transaction system is also provided with various firewalls for security purposes. In particular, communications into the web cluster 710 and the integration cluster 720 are protected by firewalls 741 and 742 respectively, while firewall 743 protects communications between integration cluster 720 and application cluster 730, and firewall 744 protects communications between application cluster 730 and database cluster 740.

The layered and clustered architecture of FIGS. 6 and 7 is highly scalable, and also provides redundancy in case of the failure of any given system component. Logical separation of the application components provides the ability to run the components in physically separate environments to meet increasing load requirements, which could easily exceed one million transactions per month.

It will be appreciated however that the application and physical architectures of FIGS. 6 and 7 are provided by way of example only. The skilled person will be aware of other possible implementations, dependent upon the particular circumstances of any given system.

The following section sets out some of the main features of the payment transaction system in accordance with one embodiment of the invention:

### Flexible Supplier Financing

The system allows the Supplier to draw down an approved payment online through a secure user interface (all payments are less finance costs and applicable bank fees).
A configurable acceptable function can be used to enforce acknowledgement of payment validity and assignment of a payment to the bank by the supplier, prior to processing of the early payment draw down.
The Supplier can request early receipt of groups or portions of approved payments subject to an agreed minimum amount which is system configurable. The finance cost calculation is clearly shown to the Supplier for any early receipt prior to acceptance and allows for the various banking system payment options determined by geography and currency.
The Supplier can schedule early draw down for any date prior to the due date. The system calculates the fees charged for early payment based on the selected date and processes the payment, given due allowance for payment method, on that date.

### Tiered Financing Parameters

The system allows discrete financing parameters (base rates, early payment rates, reward share policies and fees) configurable for each Buyer. These can be tiered by Supplier, by value, by currency or by Supplier category.

### Extended Buyer Financing Option

The system allows the Buyer to delay the repayment of its payables to the Bank on terms agreed between the Buyer and the Bank.
The Supplier still receives their payment as set by the due date in the Buyer future dated payment instruction.

### Buyer Finance Limits

The Bank is able to configure an agreed credit limit per Buyer. The Bank and the Buyer are notified when Bank payments, after allowing for receipt of assigned Buyer payments, exceed a configurable percentage of this credit limit.

### New Payables Notification

The Supplier is notified by email when a new approved payable instruction (receivable) is available in the system.
The contents and recipients of the email notification can be configured per Buyer/Supplier.
The Buyer/Bank is able to configure the minimum payment threshold amount for which Supplier notifications are generated.

### Automated Supplier Remittance Advice

The Supplier receives an email/electronic remittance with payable details as supplied to the system by the Buyer and payment details as supplied by the Bank.
The system can allow the Supplier to download a remittance advice in a pre-determined format.

### International Standards

The system conforms to the RosettaNet Remittance Advice XML schema standard (PIP 3C6: Notify of Remittance Advice, http://www.rosettanet.org/pip3c6).
Payment status messages from the system conform to the applicable TWIST standard.

### Buyer Integration

The system's current capabilities for interfacing with the Buyer's ERP system are via RosettaNet/TWIST/SWIFT over FTP, HTTP and MQSeries from IBM Corporation.
The system can integrate with other proprietary formats as required utilising the integration layer components.

### Buyer Matching and Reconciliation

The system is able to generate reconciliation data to help the Buyer to reconcile their bank statement with their payables file and the payments made by the Bank.

### Bank Integration

The system's current capabilities for interfacing with the Bank's systems are via RosettaNet/TWIST/SWIFT over FTP, HTTP and MQ.
The system, via the integration components, can operate with other Bank formats and host systems (e.g. CEMTEX for AUD or SWIFT for international payments) as required.

### User Management

The Bank is able to register multiple Buyers to the system.
The Bank is able to register multiple Suppliers to the system.
The Bank is able to create and manage any number of new users to the system on behalf of the Buyer, Supplier and Bank. This includes the creation of roles and permissions and editing of account details.

### Security Access Control

The system provides three tiered security based on userID, organisation and role.
The system can be configured to synchronise users and rights with the Bank's authentication system.

### Data Security

Only data specific to the Bank's Buyers and their Suppliers is visible within the system and is controlled by the Bank.
Buyers and Suppliers can only access their data with credentials supplied by the Bank.
The Supplier can view future dated payment instructions and accept early receipt of funds from multiple Buyers who are clients of the Bank.

### Payment Exception Notification

The system notifies Bank and Buyer when a payment instruction is received that does not have enough information to make a payment to a supplier (e.g. no account number).
The system notifies the Supplier by email if a requested payment was not able to be processed by the Bank on receipt of exception data from Bank.
The system provides the ability for the Bank to reverse failed payments.
The system provides the ability for the Bank to cancel a payment at the request of the Buyer.

### Multi-Currency

The system can operate in multiple currencies concurrently.
The system provides an on-line views of Supplier receivables in multiple currencies that can also be exported to an ERP application.
Normalisation to a single currency is possible given access to the Bank's rate data.

### Reporting

Each user is able to view, sort, filter and export data. Views include: Payables Summary, Payments/Receipts Summary, Transaction Summary. The system may also support additional material for view by the Supplier, such as non-approved invoices, together with supply chain data, such as purchase orders and goods received notes.
Views allow drill downs to display individual payments and associated payables information, including original remittance details.
For the Bank and the Buyer there are also account status Profit and Loss views sortable by Buyer, Supplier or by value.

### Supplier Assignment

The system allows a Supplier to assign all or part of a payment to a third party within the system, such as another Supplier, for example to assist with payments between suppliers. This may be used where there is a chain of suppliers leading ultimately to the Buyer, and payment from the Buyer can then be passed down the chain in the reverse direction.

In conclusion, although a variety of particular embodiments have been described in detail herein, it will be appreciated that this is by way of illustration only. For example, although the system described herein has primarily been presented in the context of a single bank, it could also be implemented on behalf of multiple banks, or perhaps a consortium of banks, and so support buyers associated with all participating banks. The skilled person will be aware of many further potential modifications and adaptations that fall within the scope of the claims and their equivalents.

What is claimed is:

1-44. (canceled)

45. A method of operating a payment transaction system by a first party comprising:
receiving an instruction for a first transaction, wherein the instructed first transaction is directed from a second party to a third party, and the transaction instruction includes a first transaction date on which the payment transaction system is to give effect to the first transaction;
storing said transaction instruction into a database;
permitting said third party to access transaction instructions stored in the database that are directed to the third party;
receiving a request from the third party to bring forward at least in part the instructed first transaction;
in response to said request, redirecting the first transaction at least in part from the third party to the first party, and creating a new instruction for a second transaction in the system, wherein said second transaction is directed from the first party to the third party and has a second transaction date which is prior to said first transaction date.

46. The method of claim 45, further comprising storing an instruction in respect of the second transaction into the database.

47. The method of claim 45, further comprising giving effect to the second transaction on the second transaction date, and to the redirected first transaction on the first transaction date.

48. The method of any claim 45, wherein the third party specifies said second transaction date.

49. The method of claim 45, wherein the third party specifies that said second transaction corresponds to a first component of the first transaction, and the method further comprises creating a third transaction from the first party to the third party, wherein said third transaction has a transaction date equal to the first transaction date and a value equal to a second component of the first transaction, wherein said first and second components correspond to a total value of the first transaction.

50. The method of claim 45, further comprising monitoring transactions from the second party that are redirected from the third party to the first party, and raising an alert when the monitored transactions exceed a predetermined threshold.

51. The method of claim 50, further comprising, in response to said alert, preventing further transactions from the second party from being redirected.

52. A method of operating a payment transaction system by a financial institution comprising:
receiving an instruction for a first future dated payment, wherein the instructed first future dated payment is directed from a buyer to a supplier, and the instruction includes a first payment date on which the system is to give effect to the first future dated payment instruction;
storing said first future dated payment instruction into a database;
permitting said supplier to access future dated payment instructions stored in the database that are directed to the supplier;
receiving a request from the supplier to bring forward at least in part the instructed first future dated payment; and
in response to said request, redirecting the instructed first future dated payment at least in part from the supplier to the financial institution, and creating a new instruction for a second payment, wherein said second payment is directed from the financial institution to the supplier and has a second payment date which is prior to said first payment date.

53. A method of operating a payment transaction system by a financial institution comprising:
receiving an instruction for a first future dated payment, wherein the instructed first future dated payment is directed from a buyer to a supplier, and the instruction includes a first payment date on which the system is to give effect to the first future dated payment instruction and a first currency in which the payment is to be made;
storing said first future dated payment instruction into a database;
permitting said supplier to access future dated payment instructions stored in the database that are directed to the supplier;
receiving a request from the supplier to convert at least in part the instructed first future dated payment into a second currency; and
in response to said request, redirecting the instructed first future dated payment at least in part from the supplier to the financial institution, and creating a new instruction for a second payment, wherein said second payment is directed from the financial institution to the supplier and is in said second currency.

54. A method of operating a central repository for instructions for transactions, said method comprising:
receiving multiple transaction instructions from at least one originator, each transaction instruction specifying the originator and a target, and further specifying a date on which the transaction is to be initiated, wherein the multiple received transactions specify different targets;
storing the received multiple transaction instructions into a database;
permitting a target to access from the database those transactions instructions out of the multiple received transaction instructions for which it is specified as a target; and
initiating the multiple transaction instructions on the specified date for each transaction.

55. A method of operating a central repository for future dated payment instructions, said method comprising:
receiving multiple future dated payment instructions from at least one buyer, each transaction instruction specifying the buyer and a supplier to whom the payment instruction is directed, and further specifying a date on which the payment is to be initiated, wherein the multiple received future dated payment instructions specify different suppliers;
storing the received multiple future dated payment instructions into a database;
permitting a supplier to access from the database those future dated payment instructions out of the multiple received future dated payment instructions for which it is specified as the supplier; and
initiating the multiple future dated payments on the specified date for each instruction.

56. The method of claim 55, further comprising identifying all the multiple future dated payment instructions directed to a particular supplier, and providing summary information in respect of the identified payment instructions.

57. The method of claim 56, wherein the multiple future dated payment instructions are in two or more different currencies, and providing the summary information includes normalising the identified payment instructions to a single currency.

58. A computer program product comprising machine instructions for implementing a method of operating a payment transaction system by a first party comprising:
receiving an instruction for a first transaction, wherein the instructed first transaction is directed from a second party to a third party, and the transaction instruction includes a first transaction date on which the payment transaction system is to give effect to the first transaction;
storing said transaction instruction into a database;
permitting said third party to access transaction instructions stored in the database that are directed to the third party;
receiving a request from the third party to bring forward at least in part the instructed first transaction;
in response to said request, redirecting the first transaction at least in part from the third party to the first party, and creating a new instruction for a second transaction in the system, wherein said second transaction is directed from the first party to the third party and has a second transaction date which is prior to said first transaction date.

59. The computer program product of claim 58, wherein the method further comprises giving effect to the second transaction on the second transaction date, and to the redirected first transaction on the first transaction date.

60. The computer program product of claim 58, wherein the third party specifies that said second transaction corresponds to a first component of the first transaction, and the method further comprises creating a third transaction from the first party to the third party, wherein said third transaction has a transaction date equal to the first transaction date and a value equal to a second component of the first transaction, wherein said first and second components correspond to a total value of the first transaction.

61. The computer program product of claim 58, wherein the method further comprises monitoring transactions from the second party that are redirected from the third party to the first party, and raising an alert when the monitored transactions exceed a predetermined threshold.

62. The computer program product of claim 61, wherein the method further comprises, in response to said alert, preventing further transactions from the second party from being redirected.

63. A payment transaction system for operation by a first party comprising:
a data input for receiving an instruction for a first transaction, wherein the instructed first transaction is directed from a second party to a third party, and the transaction instruction includes a first transaction date on which the payment transaction system is to give effect to the first transaction, and for receiving a request from the third party to bring forward at least in part the instructed first transaction;
a database for storing said transaction instruction, wherein said third party is permitted to access transaction instructions stored in the database that are directed to the third party; and
control logic responsive to said request to redirect the first transaction at least in part from the third party to the first party, and to creating a new instruction for a second transaction in the system, wherein said second transaction is directed from the first party to the third party and has a second transaction date which is prior to said first transaction date.
